(19) United States
(12) Patent Application Publication
(10) Pub. No.: US 2010/0179868 A1
(43) Pub. Date: Jul. 15, 2010

(54) METHOD AND SYSTEM FOR ENABLING INCENTIVE BASED GROUP DISCOUNT PRICING IN ONLINE STORES

(76) Inventor: Juan Miguel del Rosario, Larchmont, NY (US)

Correspondence Address: MICHAEL RIES, 318 PARKER PLACE, OSWEGO, IL, 60543, US

(21) Appl. No.: 12/685,565

(22) Filed: Jan. 11, 2010

Related U.S. Application Data
(60) Provisional application No. 61/144,006, filed on Jan. 12, 2009.

(51) Int. Cl. G06Q 30/00; G06F 15/16

(52) U.S. Cl. 705/14.16; 705/14.23; 709/206

(57) ABSTRACT

A method and system for providing group discount pricing to individuals. A first customer orders a product from an online store and elects to defer delivery for a finite period of time. The online store provides the first customer with the ability to communicate with other persons to invite them to purchase a product from the online store. The online store assigns a purchase code which associates the other persons as members of the first customer's purchase group when any one of the others purchase a product and agrees to defer delivery for the finite period of time. The online store assigns a discount price to each product as a sale is completed and is added to the purchase group where the discount can be dynamically adjusted by the online store based on criteria that is determined by the online store.

### REFERENCE TO RELATED APPLICATIONS

This patent application claims the benefit of U.S. Provisional Application No. 61/144,006 filed on January 12^{th}, 2009, the disclosure of which is incorporated herein in its entirety by reference.

### BACKGROUND OF THE INVENTION

1. Field of the Invention

The present invention relates to a method and system for enabling group discount pricing in online retail stores which is incentive based and capitalizes upon the social network revolution that has emerged in recent years.

2. Description of Related Art

Methods and systems for providing online shopping over a communication network for a product at a price is known in the prior art. More specifically, by way of example, U.S. PreGrant Publication No. 2009/0106162 to Shimansky discloses an on-line shopping system for selling a product over an electronic communication network such as the Internet. The shopping system comprises an e-commerce supplier processor, which is accessible by a number of potential buyers of the product, via the Internet. The processor has software executable thereon which is configured to receive binding on-line purchase offers from buyers of the product. The buyers will be required to register on-line as part of a buying group. The software is operable to complete the sales transactions at a future end price that is the same as or lower than the starting price and that is determined by the number of buyers in the buying group, when either of an expiry date of the supplier's offer or a minimum sales price is achieved.

U.S. PreGrant Publication No. 2008/0082420 to Kargman; et al. discloses a method which provides for group purchasing of a product or service, comprising determining, by a first customer, a product or service to purchase from a vendor, contacting, by the first customer, a second customer interested in purchasing the product or services, establishing a customer-defined group identity with the first and second customer being group members, purchasing the product or service from the vendor by the first and second customer using the group identity, and providing, by the vendor, a benefit that is at least one of a pre-purchase incentive and a post-purchase reward to the first and second customer based on the group identity. The sequencing of the method steps can be varied, and various incentive and communication arrangements can also be varied.

U.S. PreGrant Publication No. 2005/0203813 to Welter; et al. discloses a computer-implemented system for managing purchasing orders for a plurality of items to be purchased. The system includes a computer implemented purchase order management interface, the purchase order management interface configured to display data associated with a plurality of purchase orders, a purchase order generation application configured to allow a user to generate a new purchase order or modify an existing purchase order, a purchase order procurement application configured to allow a user to obtain financing for purchase order that has failed a budget check, and an event-driven purchase order controlling application configured to allow a user to review existing purchase orders for event-driven information related to the purchase order.

### SUMMARY OF THE INVENTION

In an exemplary embodiment of the present invention, there is disclosed a method for providing group discount pricing to individuals comprises:

ordering by a first customer a product from an online store;

electing by said first customer to defer delivery of said product for a finite period of time;

providing the first customer with the ability to communicate with at least one other person to invite said other person to purchase a product from the online store;

assigning a purchase code which associates the other person as a member of said first customer's purchase group when said other person purchases a product from the online store and agrees to defer delivery for said finite period of time; and

assigning a discount price by said online store to each product as a sale is completed and the product is added to the purchase group;

wherein said discount is dynamically adjusted by said online store based on criteria that is determined by said online store.

In another exemplary embodiment of the present invention, there is disclosed a system for providing group discount pricing to individuals comprising:

ordering by a first customer a product from an online store;

electing by said first customer to defer delivery of said product for a finite period of time;

providing the first customer with the ability to communicate with at least one other person to invite said other person to purchase a product from the online store;

assigning a purchase code which associates the other person as a member of said first customer's purchase group when said other person purchases a product from the online store and agrees to defer delivery for said finite period of time; and

assigning a discount price by said online store to each product as a sale is completed and the product is added to the purchase group;

wherein said discount is dynamically adjusted by said online store based on criteria that is determined by said online store.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a flow diagram of an initial user purchase phase and start of customer acquisition phase in accordance with the principles of the invention;

FIG. 2 is a flow diagram of the purchase phase for new participants in a “purchase group” and new site visitors in accordance with the principles of the invention;

FIG. 3 is a flow diagram of a “Purchase group” group discount price tracking and rewards process in accordance with the principles of the invention;

FIG. 4 is a detail product web page showing “Start a purchase group” button in accordance with the principles of the invention;

FIG. 5 is a detail of an invitation webpage which appears after clicking “Start a purchase group” button in accordance with the principles of the invention; and

FIG. 6 is a block diagram of a computer system for use with the present invention.

### DESCRIPTION OF THE PREFERRED EMBODIMENT

The group-discount pricing model allows online retail stores to improve overall sales revenue by distributing the sales effort down to the individual online shopper, providing them with group-discount pricing as a performance incentive.

The online store accomplishes this by providing a software system, as part of their online store, that implements a mechanism whereby online customers can capitalize upon social networking and other Internet network channels to encourage other users (friends, relatives, acquaintances) to purchase items from the store, for a limited period of time, in exchange for discounted pricing for each of the products in the aggregate sale.

Although there are auction pricing systems, and other traditional discount and variable pricing models being currently provided by online retail stores, to our knowledge, there is no system currently in use in the public domain that employs the model described for encouraging incentive group purchasing.

The Internet has changed the way in which stores and customers relate to one another. In recent years, large segments of the production and distribution process have been displaced from their traditional position. Companies such as threadless.com have distributed the design process to it's users. Ebay has distributed its entire product inventory and pricing (auction system) to its users. This trend is likely to continue. The system described enables users to increase their buying power by providing them with a system to virtually (i.e., remotely and geographically distributed) aggregate their purchases and thereby obtain preferred pricing from the online store. The online store benefits from such economics by increasing overall revenue.

The system requires software that allows a user, at the time of purchase, to elect to defer delivery of the purchased product for a limited period of time (e.g., 5 days, 15 days, etc.). The software system then provides the user with mechanisms to link, broadcast, email, and otherwise communicate with the user's friends, family, associates, inviting and encouraging them to purchase as well. For this, the software system will connect and communicate with, and otherwise capitalize upon, the vast and ever growing web of social networks sites, e.g., Twetter. As the user's friends, family, or associates independently enter the store website to purchase products, the software system uses an accompanying purchase code to relate or associate the new users back to the original user/buyer as part of his/he “purchase group”.

In addition, the software will present a list of all purchase groups on the website store front itself whose time period has not yet expired. The list will include information on the particular purchase group. For example, this may include the number of users currently participating in the purchase group, the current discount policy (see below), the current total discount percent, the time left before the purchase group expires. This is very much akin to an auction system that is typically implemented by auction sites in the sense that there is a list of “open bids” that users can participate in for a limited period. The difference here is that the price is not determined by the users but by the discount policy (see below).

The software system keeps track of all additional purchases that arise as a result of the user's effort (i.e., purchases from other users, regardless of whether they are the initiating user's friends, family or associates, or if they joined the purchase group by selecting it from the store's list of currently open purchase groups), and assigns discount pricing to each product as their sale is completed and they're added into the purchase group. At the end of the waiting period, the aggregate sale is consummated and final discount pricing applied to all products purchased by users in the purchase group.

The discount policy is dynamically adjustable by the store owner and can be tailored to match variables that are important to the store owner such as the cost of production or delivery, revenue numbers, cost of customer acquisition, or marketing, etc. A different discount policy can be generated based on a variable number of parameters of the store owner's choosing. It may include control variables such as different time period limits (e.g., 1 day, 5 days, 15 days); different “percent discount vs. time” function, a different “percent discount vs. no. of buyers” function, etc. And the discount policy may be offered in a variety of ways. For example, there may be a different discount policy for each product style, model, color or size group, season, etc. In its optimal configuration, users would be informed of the applicable discount pricing model prior to purchase.

During the entire customer acquisition phase—from the time where friends, family, and associates are invited to purchase, to the time they actually complete a purchase—is a significant opportunity for the store to market, advertise, and promote products to the individuals. The software system will connect to a state of the art advertising system to allow the store owner to automatically and intelligently present relevant promotional material to each new potential customer at various points throughout the customer acquisition process.

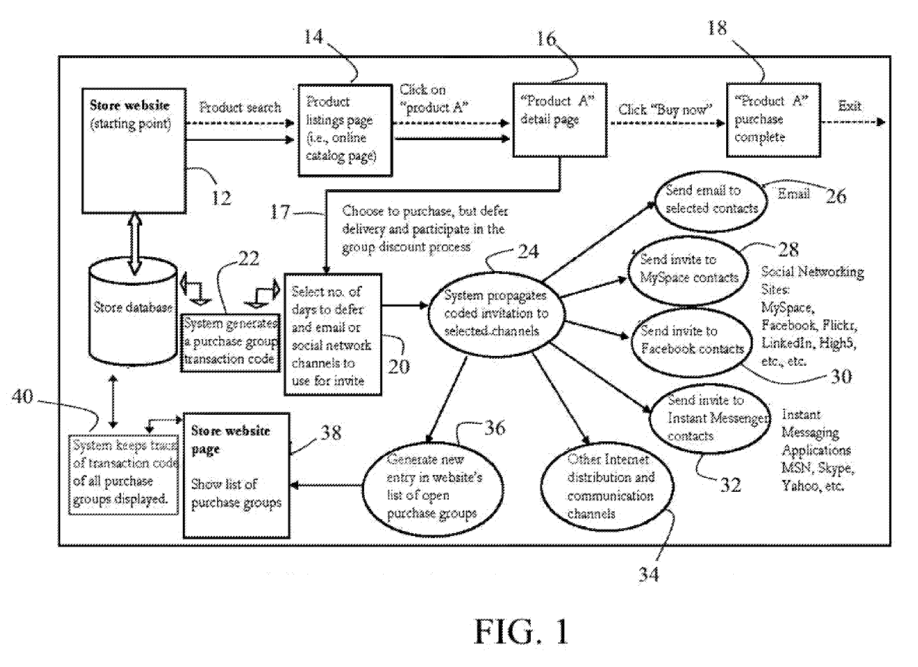

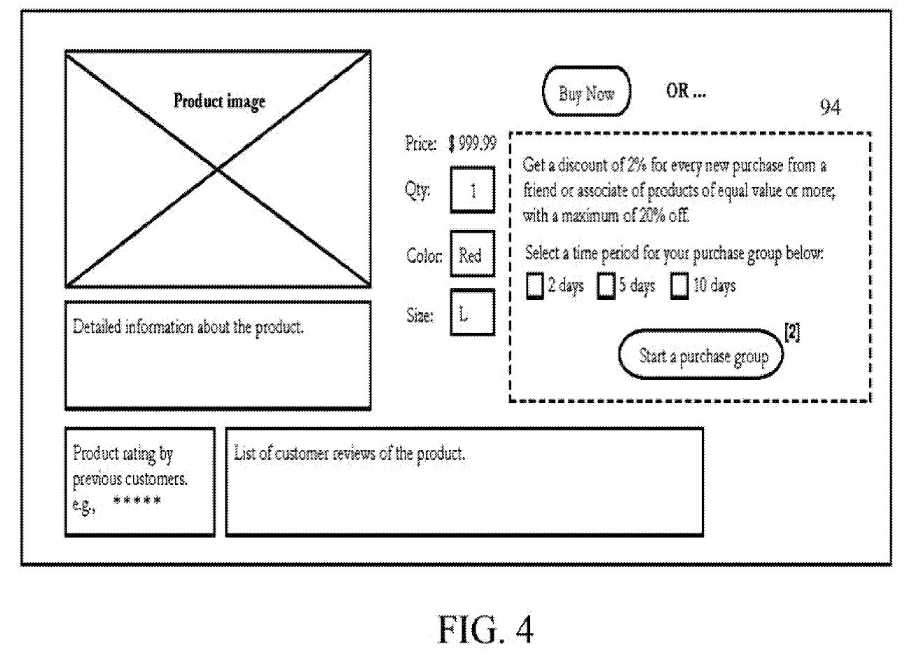

Referring to FIG. 1, there is shown a flow diagram illustrating the purchase phase of the user/buyer who initiates a purchase group with their purchase, and proceeds to the invitation and customer acquisition phase. In FIG. 1, a user enters the online stores main webpage, block 12 and begins to do a product search which leads him/her to a resulting product page, block 14. The user shows interest in a particular product, product “A” for example, and clicks on the link which takes him/her to product “A′s” detail web page, block 16. This page presents the user with the traditional “buy now” button. Likewise, it presents the user with the option to participate in the group-discount pricing program, and contains information on the discount policy that applies (see discussion on FIG. 4 below). If the user clicks on the “Buy now” button, he/she follows the traditional online-store purchase path and is taken to the payment page to complete the transaction, block 18.

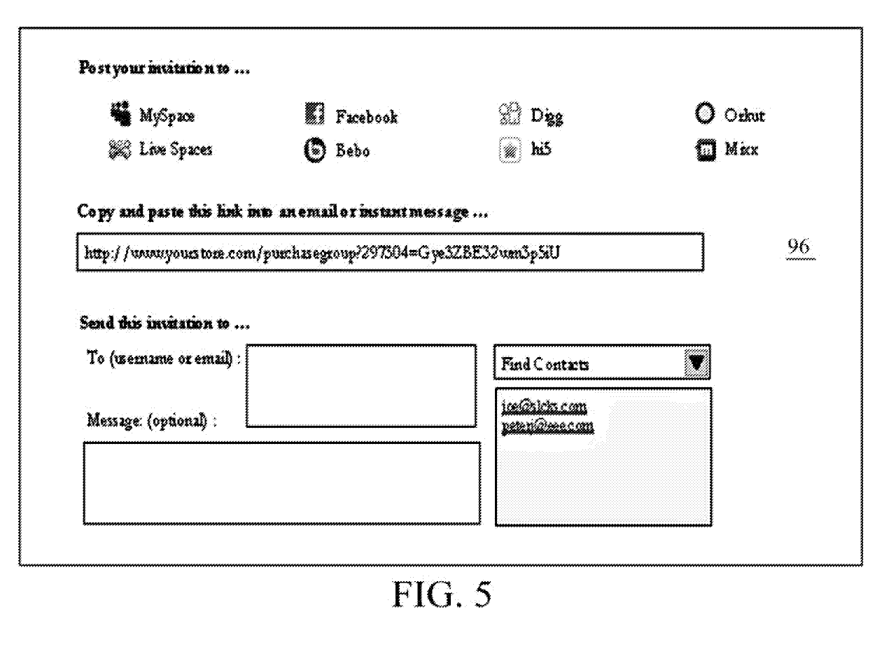

If the user chooses to participate in the group discount program, line 17, a page is displayed where the user can select the parameters available to him/her for the given discount policy applied by the store on this purchase, block 20, (and see the discussion on FIG. 5 below). Once the user has completed making his/her selections, the system generates a purchase group transaction code, block 22, that it uses to keep track of future purchases by other invited or new users who choose to join the purchase group. The system also sends out invitations via all the channels selected by the initial buyer, block 24. The figure illustrates additional options that can be included in the preferred embodiment of the invention; which includes: sending email to selected contacts, block 26, sending posts to selected friends in the user's selected social network accounts such as MySpace, Facebook, Flickr, Linkedln, HiS, Digg, etc., blocks 28, 30, sending invitations to selected friends in the user's selected instant messaging applications such as Microsoft Live Messenger, Yahoo Messenger, Skype, etc., block 32, and to any other Internet distribution or communication channel that may be available such as Google Ads, Youtube, etc., block 34. Finally, the system generates an entry, updating the list of the store website's current, active, non-expired set of purchase groups, block 36. This list is displayed to all visitors of the website, block 38, and the preferred embodiment includes features to maximize the profitability of the list such as advanced search and filtering functions, promotional and advertising content, etc. The system keeps track of and uses the purchase group transaction code to properly account for new users who choose to participate in any of the purchase groups on the list, block 40.

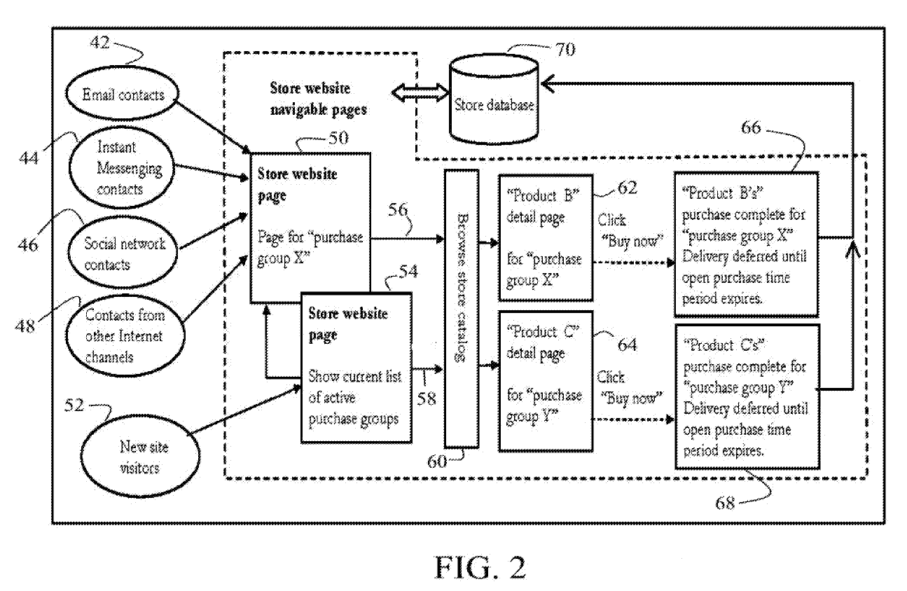

FIG. 2 shows the portion of the process that occurs as users respond to invitations from the initiating buyer, or as new visitors to the site view and respond to the site's list of active purchase groups. New users may enter the site as a result of and as a response to having received an invitation from a friend or associate who elected to start a new purchase group. This includes: invitations that arrived to them via an email; an instant messaging message; a note on their social network wall, message, or news; or some other Internet communications channel such as Youtube, blocks 42, 44, 46 and 48. In the preferred embodiment, these users will click on a link (i.e., a URL) in the message they received and will be taken to a web page, automatically generated by the system, that describes the purchase group details such as the discount terms, valid time period, etc. for the purchase group, block 50. They may then choose to participate in the purchase group by clicking on a button or link made available by the system. Invited users may also choose to navigate away from this page to the full list of active purchase groups in order to investigate other options.

Alternatively, new site visitors may have arrived to the website while browsing the Internet, block 52. In this case, the users would enter the purchase group by first purchase groups. The users may use the key word search or filters provided in order to find purchase groups that are relevant to their particular preferences, block 54. Users who select to view a particular purchase group will be taken to a page that is similar to the one where invited visitors are taken to block 50, where they can likewise elect to participate in the purchase group with a click of a button or link.

Once an invited user or new visitor has elected to participate in a purchase group, path 56, 58, the system takes them to the store catalog where they begin the buying process, block 60. During the rest of the buying process, a user is tagged by the system as belonging to the purchase group he/she selected, and any purchases he/she makes will be credited towards that purchase group, and discount rewards for the purchase group will be awarded back to the user. Moreover, the user (and his/her purchases) will belong to the purchase group until he/she elects to go back and select a new purchase group to belong to. Once that is done, the user and all his/her subsequent purchases will be tracked by the system as belonging to the new (i.e., the latest) purchase group that the user selected.

From the catalog page, the user purchases an item just as before, by going to the product detail page for the product he/she wishes to purchase, blocks 62, 64. Once there, he/she consummates the sale by clicking on the “Buy now” button. This is a bit different from the path taken by our initial buyer at the stage in the buying process (i.e., in FIG. 1, block 16 of the discussion above). Depending upon the implementation, the system may allow the user the option to choose to initiate a new purchase group (i.e., by following the path of the initial buyer—FIG. 1, line 17). In this case, a new purchase group will be formed by the system in the manner previously discussed. Depending upon the implementation, the purchase may be associated with the purchase group the user elected earlier, or with the new purchase group.

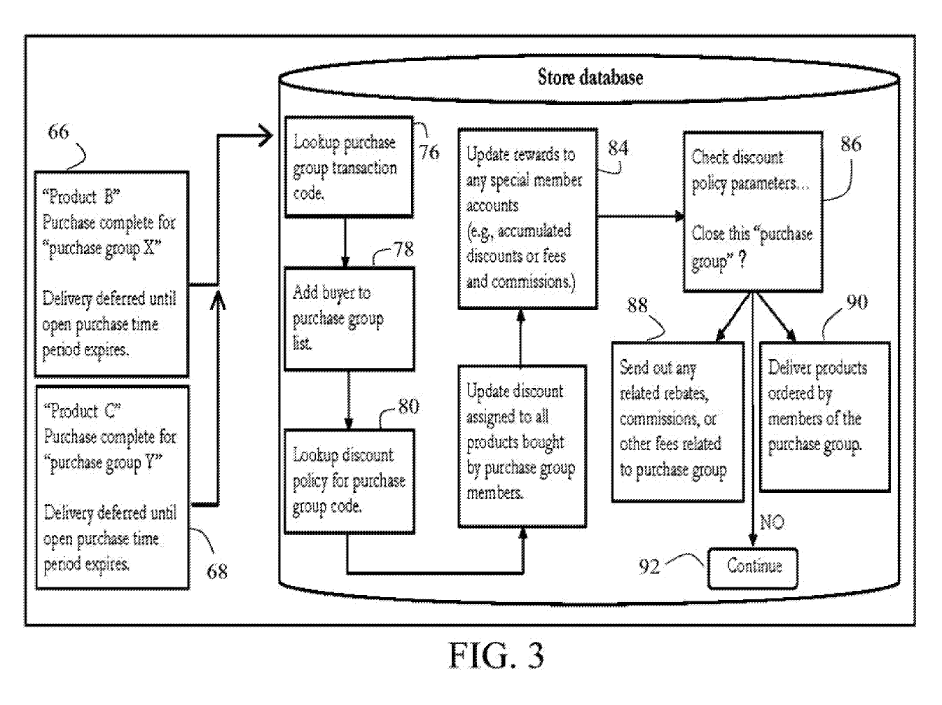

If the user purchases a product under a purchase group, the system will keep track of the purchase under that purchase group, blocks 66, 68, and perform all the necessary related accounting in the system, block 70, and illustrated further in FIG. 3). In the preferred embodiment of the system, product delivery will be kept pending until the time limit on the purchase group has expired and the final discount price has been established.

FIG. 3 describes the preferred embodiment of the process flow that the system undertakes once a user has completed a purchase as a member of a purchase group. The system begins processing purchase group purchases as soon as a purchase has been completed, blocks 66, 68. This is a continuation of the point described briefly above (FIG. 2, blocks 66, 68). The system begins processing, block 76, by looking up the purchase group transaction code records. The user's buyer information is entered into the purchase group buyer records along with the purchase transaction records, block 78. The discount policy associated with the purchase group is queried, block 80, and the discount to be applied to the purchase group as a result of this latest purchase is calculated, block 82, and the records updated. Depending upon the implementation, the system then updates the value of any rewards (e.g., in the form of accumulated points, discounts, fees, or commissions, etc.) accrued and that may be owed to special members or affiliates associated with the purchase group, block 84. Once all record updates have been performed, the system checks to see if the purchase group's (automatically advancing) time limit has now expired, block 86. If so, in the preferred embodiment, the system sends out to relevant parties any accumulated rewards (e.g., rebates, commissions, etc.) related to the purchase group, block 88. Also, the system delivers all the products purchased as part of the purchase group to the members of the purchase group that purchased them, block 90. If the purchase group time limit has not yet expired, then depending upon the implementation, the system will simply continue to wait to process the next purchase, block 92.

FIG. 4 describes the preferred embodiment of a layout for the detail product web page that contains the button to initiate a purchase group. Referring to FIG. 4, the page presents the user with information that is typical for product detail pages. These include: a product image; a detailed description of the product; an average consumer rating; a list of product reviews by previous buyers; the price; the order quantity; other product parameter choices (e.g., color, size, etc.); and the “Buy now” button. The system incorporates a new section 94 into this traditional layout. The section helps the user make the choice to start a purchase group. Within the section, there may be a description of the discount policy that applies for any purchase group involving this product; a selection of choices for the time limit the user wishes to establish for the purchase group; and a “start a purchase group” button that the user has to click in order to initiate the purchase group. There may also be other promotional text to further entice the use to start a purchase group. Once the user has elected to start a purchase group by clicking on the “start a purchase group” button, they are taken to a page that helps them send out purchase group invitations.

FIG. 5 describes the preferred embodiment of a layout for the purchase group invitation page that the user is led to after electing to start a purchase group. The purchase group invitation page 96 has several sections. One section allows users to post invitations onto various possible social networks in existence. The user can choose the one(s) in which they have an account and a list of friends that they'd like to extend the invitation to. Another section can contain a link to the purchase group webpage (as described above for FIG. 2, block 50). The user can take this link and email it to friends or pass it to them using any instant messaging applications. There may also be a section where the user can select an email server (e.g., hotmail, gmail, etc.) where they have an account, login, select contacts, and send them an email invitation regarding the purchase group; the link will automatically be inserted into the email by the system.

Many variations of the invention will occur to those skilled in the art. Some variations include:

A different purchase fulfillment policy. That is, users who make a purchase as a member of a purchase group (whether they are the user who originates the purchase group or not), may not be required to wait until the purchase group time limit has expired before the product is shipped to them. The products may be shipped immediately and only the discount rewards may be mailed to them subsequent to the purchase group expiration date/time, somewhat akin to a rebate.

Other implementations may employ a reward system such that they provide purchase group initiators with additional incentive to promote conversion of invitations into further sales. This may be done by rewarding initiators who exceed a certain number of additional sales with accumulated points to be exchanged for cash, prizes, etc. at a later date; further discounts; commissions; further rebates; etc.

Member or affiliate programs may be included as part of the system. With membership accounts for example, users who perform well on generating additional sales for purchase groups that they initiate may be rewarded discount value by the system which is accrued in the user's member account. These may be redeemed at any time towards, for example, a purchase or for cash.

Affiliate programs may allow users to initiate purchase groups that they actively “market” to the friends and associates, but also to the general public. They may market these purchase groups online using the wide variety of online advertising techniques that are available. In exchange, the affiliate marketer may be rewarded with commissions for every incremental sale, profit, or new customer they acquire for the store.

Numerous variations may be generated in relation with the discount policy. Discount policy may engender variations in the payout scheme, incentives provided, relationship and/or time frame between the purchase and the customer acquisition reward, etc.

Other variations may call for entire modules to be integrated with the system in the invention. For instance, at several points after a purchase group is initiated, there are numerous opportunities for additional advertising and marketing as a result of the purchase group invitation process. In fact, the entire customer acquisition phase—from the time where friends, family, and associates are invited to purchase, to the time they actually complete a purchase—is a significant opportunity for the store to market, advertise, and promote products to the individuals. The software system may be connected to a state of art advertising system to allow the store owner to automatically and intelligently present relevant promotional material to each new potential customer at various points throughout the customer acquisition process.

The invention may be incorporated into an already existing, functioning, traditional online store. Although some embodiments are shown to include certain features, it is understood that any feature disclosed herein may be used together or in combination with any other feature on any embodiment of the invention. It is also understood that any feature may be specifically excluded from any embodiment of an invention.

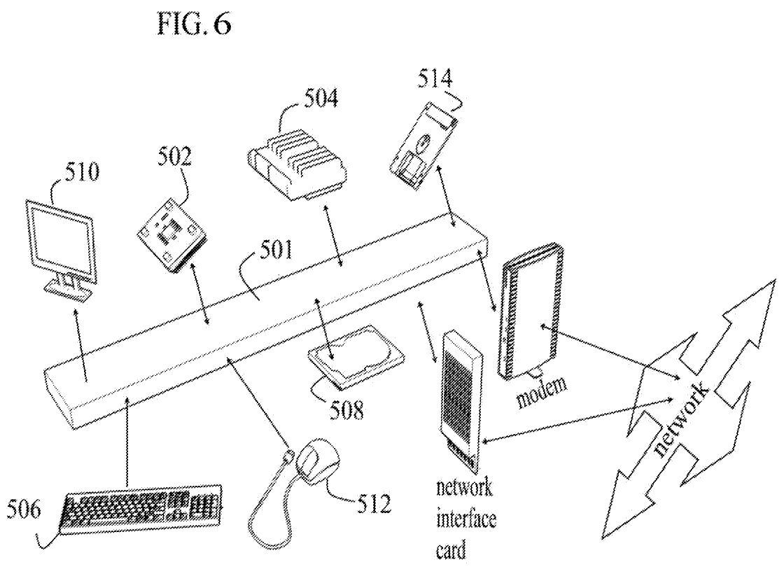

The present invention can be used on any properly configured general purpose computer system, such as the system shown in FIG. 6. Such a computer system 500 includes a processing unit (CPU) 502 connected by a bus to a random access memory 504, a storage device 508, a keyboard 506, a display 510 and a mouse 512. In addition, there is a device 514 for entry of data and software, including software embodying the present invention, into the system. An example of such a computer can be a Dell personal computer operating on the Microsoft Windows operating system, or Linux, Macintosh, etc. The invention can also be used on a laptop computer or mobile device.

The various method embodiments of the invention will be generally implemented by a computer executing a sequence of program instructions for carrying out the steps of the method, assuming all required data for processing is accessible to the computer. The sequence of program instructions may be embodied in a computer program product comprising media storing the program instructions. As will be readily apparent to those skilled in the art, the present invention can be realized in hardware, software, or a combination of hardware and software. Any kind of computer/server system(s)—or other apparatus adapted for carrying out the methods described herein—is suited. A typical combination of hardware and software could be a general-purpose computer system with a computer program that, when loaded and executed, carries out the method, and variations on the method as described herein.

The present invention may be embodied as a system, method, or computer program product. Accordingly, the present invention may take the form of a hardware embodiment, a software embodiment, or an embodiment combining software and hardware. Furthermore, the present invention may take the form of a computer program product embodied in any tangible medium of expression having computer-usable program code embodied in the medium.

Any combination of one or more computer usable or computer readable medium(s) may be utilized. Specific examples of the computer-readable medium can include: a hard disk, a random access memory (RAM), a read-only memory (ROM), an erasable programmable read-only memory (EPROM), or Flash memory, a portable compact disc read-only memory (CD-ROM), etc. In the context of this document, a computer-usable or computer-readable medium may be any medium that can be used by or in connection with the instruction execution system or apparatus. Computer program code for carrying out operations of the present invention may be written in any combination of one or more programming languages. The program code may execute entirely on the user's computer, partly on the user's computer, as a stand-alone software package, partly on the user's computer and partly on a remote computer or entirely on the remote computer or server.

The present invention is described above with reference to a computer program products according to an embodiment of the invention. It will be understood that each block, and combinations of blocks shown, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart or blocks.

These computer program instructions may also be stored in a computer-readable medium that can direct a computer or other programmable data processing apparatus to function in a particular manner, such that the instructions stored in the computer readable medium produce an article of manufacture including instructions means which implement the function specified in the blocks.

The computer program instruction may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions specified.

The flowchart in the figure illustrates the architecture, functionality, and operation of possible implementations of systems, methods and computer program products according to various embodiments of the present invention. In this regard, each block in the flowchart may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact be executed substantially concurrently, or the blocks may sometimes be executed in the reverse order, depending upon the functionality involved. It will also be noted that each block of the flowchart illustration, and combinations of blocks in the flowchart illustration, can be implemented by special purpose hardware-based systems that perform the specified functions or acts, or combinations of special purpose hardware and computer instructions.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A method for providing group discount pricing to individuals comprises:
ordering by a first customer a product from an online store;
electing by said first customer to defer delivery of said product for a finite period of time;
providing the first customer with the ability to communicate with at least one other person to invite said other person to purchase a product from the online store;
assigning a purchase code which associates the other person as a member of said first customer's purchase group when said other person purchases a product from the online store and agrees to defer delivery for said finite period of time; and
assigning a discount price by said online store to each product as a sale is completed and the product is added to the purchase group;
wherein said discount is dynamically adjusted by said online store based on criteria that is determined by said online store.

2. The method of claim 1 wherein said finite period of time for deferring delivery of said produce is determined by said first customer up to a period of time that is set by said online store.

3. The method of claim 1 wherein said online store provides said first customer with the ability to communicate with at least one other person via the online store communication network to offer said person the opportunity to purchase a product from the online store.

4. The method of claim 3 wherein said method of communicating with at least one other person includes at least broadcast, email, instant messaging or social networking site.

5. The method of claim 3 wherein said first customer is provided the opportunity to communicate with a person known to him/her such as a friend, family or associate via the online store communication network.

6. The method of claim 3 wherein said discount is assigned to each product as the sale of the product is completed.

7. The method of claim 6 wherein said discount can vary for each product sold.

8. The method of claim 7 wherein a customer is informed of the applicable discount pricing prior to purchase.

9. The method of claim 3 wherein the online store provides a list of all purchase groups whose time period has not yet expired which is available for a new customer to join as a member of said purchase group.

10. The method of claim 9 wherein said list can include the number of users currently participating in the purchase group, the current discount policy, the current total discount percent, the time left before the purchase group expires.

11. A system for providing group discount pricing to individuals comprising:
ordering by a first customer a product from an online store;
electing by said first customer to defer delivery of said product for a finite period of time;
providing the first customer with the ability to communicate with at least one other person to invite said other person to purchase a product from the online store;
assigning a purchase code which associates the other person as a member of said first customer's purchase group when said other person purchases a product from the online store and agrees to defer delivery for said finite period of time; and
assigning a discount price by said online store to each product as a sale is completed and the product is added to the purchase group;
wherein said discount is dynamically adjusted by said online store based on criteria that is determined by said online store.

12. The system of claim 11 wherein said finite period of time for deferring delivery of said produce is determined by said first customer up to a period of time that is set by said online store.

13. The system of claim 11 wherein said online store provides said first customer with the ability to communicate with at least one other person via the online store communication network to offer said person the opportunity to purchase a product from the online store.

14. The system of claim 13 wherein said method of communicating with at least one other person includes at least broadcast, email, instant messaging or networking site.

15. The system of claim 13 wherein said first customer is provided the opportunity to communicate with a person known to him/her such as a friend, family or associate via the online store communication network.

16. The system of claim 13 wherein said discount is assigned to each product as the sale of the product is completed.

17. The system of claim 16 wherein said discount can vary for each product sold.

18. The system of claim 17 wherein a customer is informed of the applicable discount pricing prior to purchase.

19. The system of claim 13 wherein the online store provides a list of all purchase groups whose time period has not yet expired which is available for a new customer to join as a member of said purchase group.

20. The system of claim 19 wherein said list can include the number of users currently participating in the purchase group, the current discount policy, the current total discount percent, the time left before the purchase group expires.
